(19) United States
(12) Patent Application Publication
(10) Pub. No.: US 2012/0295820 A1
(43) Pub. Date: Nov. 22, 2012

(54) MANAGEMENT OF CORROSION IN PHOSPHATE BRINES

(75) Inventors: Olusegun Matthew Falana, San Antonio, TX (US); Edward C. Marshall, Schwartz, TX (US); Frank Zamora, San Antonio, TX (US)

(73) Assignee: CLEARWATER INTERNATIONAL, LLC, Houston, TX (US)

(21) Appl. No.: 13/109,712

(22) Filed: May 17, 2011

(51) Int. Cl. C09K 8/03; C09K 8/28; C09K 8/58; C09K 8/66

(52) U.S. Cl. 507/128; 507/142; 507/274; 507/129; 507/239; 507/103; 507/203; 507/267; 507/135; 507/256; 507/235; 507/260

(57) ABSTRACT

Phosphate brines are disclosed having reduced corrosive ratings. The phosphate brines include an additive system that reduces the corrosiveness of the phosphate brines compared to the phosphate brines in the absence of the additive system.

### BACKGROUND OF THE INVENTION

1. Field of the Invention

Embodiments of the present invention relate to compositions including a phosphate brine having a corrosion rating in lb/ft²/yr between about 0 and about 50 for drilling, completing, and/or fracturing of oil and/or gas wells and to method for making and using same.

More particularly, embodiments of the present invention related to compositions including phosphate brine having a corrosion rating in lb/ft²/yr between about 0 and about 50 for drilling, completing, and/or fracturing of oil and/or gas wells and to method for making and using same, where the phosphate brine include an additive system. The additive system is added in amounts sufficient to reduce, minimize or eliminate corrosion properties of the phosphate brine to produce less corrosive, minimally corrosive, substantially non-corrosive or non-corrosive phosphate brines.

2. Description of the Related Art

Historically, phosphate salts are produced by reacting phosphoric or polyphosphoric acid with metal hydroxides. Prior teaching also includes use of ion exchange resin columns (see U.S. Pat. Nos. 4,935,213 and 3,993,466). While direct neutralization produces brines that might be unsuitable in applications where clear fluids are required, the use of ion exchange columns to clarify the brines is unwarranted in many large scale processes and adds to production cost.

To-date, preparations of high density phosphate brines have been difficult and limited to the production of phosphate brines having densities only up to about 15 lb/gal (Specific Gravity of 1.8). Most phosphate brines are prepared commercially by the treatment of phosphate rock so called “rock salt” (see S. M. Jasinski; “Phosphate Rock”, US Geological Survey Minerals' Yearbook, 2003 and U.S. Pat. No. 3,993,466) or phosphoric acid with alkali metal hydroxides. This process requires ready availability of the afore mentioned materials. However, demand for these reagents for other uses is high. For instance, phosphate salts find applications in pharmaceutical, agricultural and detergent industries. Thus, high demand limits production of high density brines and makes the economics of the neutralization process at best uncertain.

Until lately, there has been little interest in phosphate brines for reasons stemming from availability, paucity of chemical and physical properties data as well as detailed application studies in the oilfield industry. As such, there is no prior art teaching to the best of our knowledge on corrosion management when phosphate brines are used.

Phosphate brines constitute the heaviest unweighted brines to date and may be prepared as clear brines having weights up to a specific gravity (SG) of 2.5 (circa 21 ppg). However, their adoption as substitutes for conventional brines such as calcium or zinc halides or formate brines is limited by lack of corrosion mitigation. Thus, there is a need in the art for compositions that are capable of managing corrosive properties of phosphate brines.

### SUMMARY OF THE INVENTION

### Drilling Fluids and Methods

Embodiments of this invention provide drilling fluid compositions including a phosphate brine including an additive system, where the additive system reduces or eliminates corrosion properties of the phosphate brine and where the composition has a density at or above about 10 lb/gal.

Embodiments of this invention provide methods for drilling including drilling an oil and/or gas well with a drilling fluid composition including a phosphate brine including an additive system, where the additive system reduces or eliminates corrosion properties of the phosphate brine and where the composition has a density at or above about 10 lb/gal.

Embodiments of this invention provide systems for drilling an oil and/or gas well including supply means adapted to supply a drilling fluid composition to a drill string during drilling operations. The drilling fluid composition includes a phosphate brine including an additive system, where the additive system reduces or eliminates corrosion properties of the phosphate brine and where the composition has a density at or above about 10 lb/gal.

### Completing Fluids and Methods

Embodiments of this invention provide completion fluid compositions including a phosphate brine including an additive system, where the additive system reduces or eliminates corrosion properties of the phosphate brine and where the composition has a density at or above about 10 lb/gal.

Embodiments of this invention provide methods for completing an oil and/or gas well including completing an oil and/or gas well with a completion fluid composition including a phosphate brine including an additive system, where the additive system reduces or eliminates corrosion properties of the phosphate brine and where the composition has a density at or above about 10 lb/gal.

Embodiments of this invention provide systems for completing an oil and/or gas well including supply means adapted to supply a completion fluid composition to a completion string during well completion operations. The completion fluid includes a phosphate brine including an additive system, where the additive system reduces or eliminates corrosion properties of the phosphate brine and where the composition has a density at or above about 10 lb/gal.

### Fracturing Fluids and Methods

Embodiments of this invention provide fracturing fluid compositions including a phosphate brine including an additive system, where the additive system reduces or eliminates corrosion properties of the phosphate brine and where the composition has a density at or above about 10 lb/gal.

Embodiments of this invention provide methods for fracturing an oil and/or gas well including fracturing a formation with a fracturing fluid composition including a phosphate brine including an additive system, where the additive system reduces or eliminates corrosion properties of the phosphate brine and where the composition has a density at or above about 10 lb/gal.

Embodiments of this invention provide systems for fracturing an oil and/or gas well including supply means adapted to supply a fracturing fluid composition to a fracturing string during formation fracturing. The fracturing fluid includes a phosphate brine including an additive system, where the additive system reduces or eliminates corrosion properties of the phosphate brine and where the composition has a density at or above about 10 lb/gal.

### DEFINITIONS OF THE INVENTION

An under-balanced and/or managed pressure drilling fluid means a drilling fluid having a hydrostatic density (pressure) lower or equal to a formation density (pressure). For example, if a known formation at 10,000 ft (True Vertical Depth—TVD) has a hydrostatic pressure of 5,000 psi or 9.6 lbm/gal, an under-balanced drilling fluid would have a hydrostatic pressure less than or equal to 9.6 lbm/gal. Most under-balanced and/or managed pressure drilling fluids include at least a density reduction additive. Other additive many include a corrosion inhibitor, a pH modifier and a shale inhibitor.

The term “fracturing” refers to the process and methods of breaking down a geological formation, i.e. the rock formation around a well bore, by pumping fluid at very high pressures, in order to increase production rates from a hydrocarbon reservoir. The fracturing methods of this invention use otherwise conventional techniques known in the art.

The term “proppant” refers to a granular substance suspended in the fracturing fluid during the fracturing operation, which serves to keep the formation from closing back down upon itself once the pressure is released. Proppants envisioned by the present invention include, but are not limited to, conventional proppants familiar to those skilled in the art such as sand, 20-40 mesh sand, resin-coated sand, sintered bauxite, glass beads, and similar materials.

The term “ppg” means pounds per gallon (lb/gal) and is a measure of density.

The term “SG” means specific gravity.

The term “substantially neutral” means that the fluid has a pH of 7±1. In other embodiments, the term means that the fluid has a pH of 7±0.75. In other embodiments, the term means that the fluid has a pH of 7±0.5. In other embodiments, the term means that the fluid has a pH of 7±0.25. In other embodiments, the term means that the fluid has a pH of 7±0.2. In other embodiments, the term means that the fluid has a pH of 7±0.1. In other embodiments, the term means that the fluid has a pH of 7±0.05. In other embodiments, the term means that the fluid has a pH of 7±0.01.

The term “substantially neutralized” means that the fluid has a pH of 9±1. In other embodiments, the term means that the fluid has a pH of 9±0.75. In other embodiments, the term means that the fluid has a pH of 9±0.5. In other embodiments, the term means that the fluid has a pH of 9±0.25. In other embodiments, the term means that the fluid has a pH of 9±0.2. In other embodiments, the term means that the fluid has a pH of 9±0.1. In other embodiments, the term means that the fluid has a pH of 9±0.05. In other embodiments, the term means that the fluid has a pH of 9±0.01.

The term “MPY” means mils per year.

The term “substantially non-corrosive” means that the phosphate brines have a Corrosion (MPY—mils per year) value of less than or equal to 350. In certain embodiments, the phosphate brines have a Corrosion (MPY) value of less than or equal to 300. In certain embodiments, the phosphate brines have a Corrosion (MPY) value of less than or equal to 250. In certain embodiments, the phosphate brines have a Corrosion (MPY) value of less than or equal to 200. In certain embodiments, the phosphate brines have a Corrosion (MPY) value of less than or equal to 175.

### DETAILED DESCRIPTION OF THE INVENTION

The inventors have found that phosphate brines can be prepared having reduced corrosive properties by adding a corrosion mitigation composition or system to the phosphate brines. Currently, no proper corrosion inhibitor systems exist for phosphate brines to the best of the inventors knowledge. The inventors have found that reduced corrosive phosphate brines can be prepared by adding an additive system to the phosphate brines, where the astringency of the systems are reduced and/or eliminated to produce substantially or non-corrosive and/or non-deleterious phosphate brines. In certain embodiments, the additive system includes neutralizing agents for the phosphate brines such as acids, anhydrides, other compounds capable ofneutralizing basic phosphate brines, or mixtures or combinations thereof. Typically, phosphate brines have a pH 9. While the pH of a 1.74 SG phosphate brine (14.5 ppg) is 11, it can easily be handled and is safe for skin exposure, but is corrosive to metals. Therefore, the inventors have found that treating phosphate brines with an effective amount of a neutralizing system produces neutralized phosphate brines or a substantially neutralized phosphate brines having reduced metal corrosive propensities, having minimal corrosive propensities or are substantially non-corrosive to metals. Thus, the inventors have found that pH adjusted heavy phosphate brines or neutralized heavy phosphate brines can be prepared for use in the oilfield industry, where conventional brines cannot be used (e.g., zero discharge regulation for zinc brines) or for use in other markets and applications, where traditional heavy brines are used. In other embodiments, the additive system includes quaternary salts, amines or mixtures thereof, where the quaternary salts and amines are effective in reducing the corrosive properties of the phosphate brines. In other embodiments, the additive system includes neutralizing agents, oxygen scavengers, quaternary ammonium salts, amines, quaternary phosphonium salts, phosphines, or mixtures and combinations thereof, where the additives are present in an amount sufficient to produce phosphate brines having a corrosion rating in lb/ft²/yr between about 0 and about 50.

Phosphate brines may be generated at high neutralization reaction temperatures having densities above about 11 lb/gal. Phosphate brines may even be generated with densities of 18 lb/gal (ppg) or greater depending on the hydrogen phosphate and metal containing base used to prepare the brine. For example, the reaction of potassium monophosphate with cesium hydroxide (CsOH) yields a phosphate brine having a density of about 18 ppg.

Phosphate brines prepared as set forth above offer the flexibility to employ a direct neutralization reaction procedure or “indirect” or displacement reaction procedure to produce homogenous or heterogeneous (mixed) cation brines. The resultant brines are clear, thus making them suitable for wide applications. In certain embodiments, indirect methods are used to preclude reaction run, run away reaction, and other difficulties associated with procedures using a direct neutralization reaction.

The processes of the present invention can be used to prepare heavy brines comprising a mixture of phosphate salts, at high neutralization reaction temperatures with selective use of mono or di-alkali metal hydrogen phosphates. Some mixed cation phosphate compositions are known in the art including ammonium magnesium phosphate (NH₄MgPO₄), sodium aluminum phosphates [NaAl₃H₁₄(PO₄)₈.4H₂O & Na₃Al₂H₁₅(PO₄)₈] (see, e.g., Kirk-Othmer, Encyclopediea of chemical Technology, 3^{rd} edition, vol 17, p 447, 1982), cesium sodium (or potassium) hydrogen phosphates (CsNaHPO₄ or CsKHPO₄). However, cesium potassium phosphates have only been prepared on small scale for use as catalysts to effect transformation of organic molecules into lactone (see, e.g., U.S. Pat. No. 5,502,217) or ester (see, e.g. U.S. Pat. No. 6,723,823). Further details on phosphate brine preparation maybe found in US 20100305010 published on Dec. 2, 2010.

### Methods for using Phosphate Brines of this Invention

### Fracturing

The present invention provides methods for fracturing formations with a fracturing fluid including a phosphate brine including an additive system, where the additive system reduces or eliminates corrosion properties of the phosphate brine and where the composition has a density at or above about 10 lb/gal. The method includes the step of pumping the fracturing fluid including a proppant into a producing formation at a pressure sufficient to fracture the formation to enhance productivity, where the proppant props open newly created or widened fractures in the formation during and/or after fracturing.

The present invention provides methods for fracturing a formation with a fracturing fluid including a phosphate brine including an additive system, where the additive system reduces or eliminates corrosion properties of the phosphate brine and where the composition has a density at or above about 10 lb/gal. The method includes the step of pumping the fracturing fluid including a proppant into a producing formation at a pressure sufficient to fracture the formation to enhance productivity.

The present invention provides a method for fracturing a formation with a fracturing fluid including a phosphate brine including an additive system, where the additive system reduces or eliminates corrosion properties of the phosphate brine and where the composition has a density at or above about 10 lb/gal. The method includes the step of pumping the fracturing fluid into a producing formation at a pressure sufficient to fracture the formation to enhance productivity. The method may also include the step of pumping a fluid including a proppant after fracturing into the fractured formation so that the particles prop open newly created or widened fractures in the formation.

### Drilling

The present invention provides a method for drilling including the step of while drilling, circulating a drilling fluid, to provide bit lubrication, heat removal and cutting removal, where the drilling fluid includes a phosphate brine including an additive system, where the additive system reduces or eliminates corrosion properties of the phosphate brine and where the composition has a density at or above about 10 lb/gal. The method may be operated in over-pressure conditions or in under-balanced conditions or in managed pressure conditions. The method is especially well tailored to under-balanced or managed pressure conditions.

### Producing

The present invention provides a method for producing including the step of circulating and/or pumping a fluid into a well on production, where the fluid includes a phosphate brine including an additive system, where the additive system reduces or eliminates corrosion properties of the phosphate brine and where the composition has a density at or above about 10 lb/gal.

In all of the above phosphate brines, the density of the brines may have a density ranging between about 10 lb/gal (ppg) and about 20 ppg. In certain embodiments, the brines have a density between about 10 lb/gal (ppg) and about 18 ppg. In certain embodiments, the brines have a density between about 10 lb/gal (ppg) and about 16 ppg. In certain embodiments, the brines have a density between about 10 lb/gal (ppg) and about 15 ppg.

In all of the above phosphate brines, the modified phosphate brine compositions of this inventions have a corrosion rating in lb/ft²/yr between about 0 and about 25. In certain embodiments, the modified phosphate brine compositions of this inventions have a corrosion rating in lb/ft²/yr between about 2 and about 22. In other embodiments, the modified phosphate brine compositions of this inventions have a corrosion rating in lb/ft²/yr between about 5 and about 20. In certain embodiments, the modified phosphate brine compositions of this inventions have a corrosion rating in lb/ft²/yr between about 5 and about 18. In certain embodiments, the modified phosphate brine compositions of this inventions have a corrosion rating in lb/ft²/yr between about 5 and about 15. In certain embodiments, the modified phosphate brine compositions of this inventions have a corrosion rating in lb/ft²/yr between about 5 and about 10.

### Suitable Reagents

Suitable neutralizing agents for neutralizing phosphate brines include, without limitation, acids, anhydrides, other compounds capable of neutralizing basic phosphate brines, or mixtures or combinations thereof. Suitable acids include, without limitation, organic acids, organic acid anhydrides, inorganic acids, inorganic acid anhydrides or mixtures and combinations thereof. Exemplary acids include, without limitations, carboxylic acids (mono, di or poly), halogen containing acids such as hydrochloric acid (HCl), hydrobromic acid (HBr), etc., sulfur containing acids such as sulfuric acid, sulfonic acids, sulfinyl acids, etc., phosphoric containing acids such as phosphoric acid, polyphosphoric acid, etc. or mixtures and combinations thereof. Exemplary carboxylic acids include, without limitation, saturated carboxy acids having from 1 to about 20 carbon atoms, unsaturated carboxy acids having from about 2 to about 20 carbon atoms, aromatic acids having from about 5 to about 30 carbon atoms, saturated dicarboxy acids having from 1 to about 20 carbon atoms, unsaturated dicarboxy acids having from about 2 to about 20 carbon atoms, aromatic diacids having from about 5 to about 30 carbon atoms, saturated polycarboxy acids having from 1 to about 20 carbon atoms, unsaturated polycarboxy acids having from about 2 to about 20 carbon atoms, aromatic polyacids having from about 5 to about 30 carbon atoms, or mixtures and combinations thereof. Exemplary sulfonic acids include, without limitation, alkyl sulfonic acids, alkenyl sulfonic acids, aryl sulfonic acids, where the alkyl groups include 1 to about 20 carbon atoms, the alkenyl groups include 2 to about 20 carbon atoms and the aryl groups include 5 to about 30 carbon atoms. In all of these structures, one or more of the carbon atoms may be replaced by hetero atoms including boron, nitrogen, oxygen, sulfur, or mixtures thereof and one or more of the required hydrogen atoms to complete the valency may be replaced by a halogen including fluorine, chlorine, or bromine, a hydroxyl group, an ether group, an amine, an amide, or mixtures thereof. Exemplary anhydrides include, without limitation, anhydrides prepared from one or more of the acids listed above. In certain embodiments, the acids include methane sulfonic acid (Lutropur MSA—LMSA) from BASF Corp. USA, benzoic acid from Sigma-Aldrich Co. USA, hydrochloric acid, glycolic acid, formic acid, polyphosphoric acid, or mixtures and combinations thereof.

Suitable quaternary salts and amine for use in the additive systems of this invention include, without limitation, quaternary ammonium salts (R¹R²R³R⁴N+A⁻), quaternary phosphonium salts (R¹R²R³R⁴P⁺A⁻), amines (R¹R²R³N), phosphines (R¹R²R³P), and mixtures or combinations thereof, where the R¹, R², R³ and R⁴ are the same or different and are carbyl groups having between 1 and about 20 carbon atoms (saturated, unsaturated, cyclic, acyclic, aromatic, or mixed) and sufficient hydrogen atoms to satisfy the valence, where one or more carbon atoms may be replaced by a hetero atom or group selected from oxygen, sulfur, amido, boron, or mixtures thereof, and one or more of the hydrogen atoms can be replace by halogens, alkoxdies, or mixtures thereof and where A⁻ is a counterion. Exemplary examples of counterions include hydroxide (OH—), halogens (F—, Cl—, Br—, I—), sulfate (SO₄²⁻), nitrate (NO₃²⁻), other counterions or mixtures thereof. Exemplary examples of quaternary and amines include other additive such as CORSAF SF (CSF) available from Tetra Technologies, Inc. USA, OxBan HB™ (OBHB) available from Tetra Technologies, Inc. USA, CorrFoam™ 1 (CF-1) available from Weatherford International, USA, Triaminononane Crude (TAN) available from NOVA Molecular Technologies, Inc. USA and BARDAC® LF, a quaternary biocides, available from Lonza Inc. Allendale, N.J.

Suitable phosphate sources include, without limitation, phosphoric acid, polyphosphoric acid, mono alkali metal hydrogen phosphates, di alkali metal hydrogen phosphates, mixed di alkali metal hydrogen phosphates and mixtures or combinations thereof. Further, alkaline earth metal hydrogen phosphates are suitable. Exemplary examples include mono lithium hydrogen phosphate, mono hydrogen phosphate, mono potassium hydrogen phosphate, mono rubidium hydrogen phosphate, mono cesium hydrogen phosphate, di-lithium hydrogen phosphate, di-hydrogen phosphate, di-potassium hydrogen phosphate, di-rubidium hydrogen phosphate, di-cesium hydrogen phosphate, magnesium hydrogen phosphate and mixture or combinations thereof.

Suitable bases include, without limitation, alkali metal hydroxides, alkaline earth metal and mixtures or combinations thereof. Exemplary examples include lithium hydroxide, sodium hydroxide, potassium hydroxide, rubidium hydroxide, cesium hydroxide, magnesium hydroxide and mixtures or combinations thereof.

It should be recognized that if one wants to form a mixed phosphate brine, then one would use a suitable hydrogen phosphate and a suitable base. For example, if one wanted to prepare a potassium-cesium mixed phosphate brine, then one could start with a potassium hydrogen phosphate and cesium hydroxide or cesium hydrogen phosphate and potassium hydroxide. One can also start with cesium, potassium hydrogen phosphate and neutralize with either potassium or cesium hydroxide depending on the brine to be produced. It should also be recognized that the phosphate brines can include more than two metals as counterions by using a mixture of hydrogen phosphates and/or a mixture of bases.

### Drilling and Completion Fluids

The drilling and completion fluids of this invention, while including a heavy phosphate brine as set forth herein may also include other reagents or additives including those set forth below. Sulfur Scavenger

Suitable sulfur scavengers for use in this invention include, without limitation, amines, aldehyde-amine adducts, triazines, or the like or mixtures or combinations thereof. Exemplary examples of aldehyde-amine adduct type sulfur scavengers include, without limitation, (1) formaldehyde reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (2) linear or branched alkanal (i.e., RCHO, where R is a linear or branched alkyl group having between about 1 and about 40 carbon atoms or mixtures of carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (3) aranals (R′CHO, where R′ is an aryl group having between about 5 and about 40 carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (4) alkaranals (R″CHO, where R″ is an alkylated aryl group having between about 6 and about 60 carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (5) aralkanals (R′″CHO, where R′″ is an aryl substituted linear or branched alkyl group having between about 6 and about 60 carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines, and (6) mixtures or combinations thereof. It should be recognized that under certain reaction conditions, the reaction mixture may include triazines in minor amount or as substantially the only reaction product (greater than 90 wt.% of the product), while under other conditions the reaction product can be monomeric, oligomeric, polymeric, or mixtures or combinations thereof. Other sulfur scavengers are disclosed in WO04/043038, US2003-0089641, GB2397306, U.S. patent application Ser. Nos. 10/754,487, 10/839,734, and 10/734,600, incorporated herein by reference.

### Shale Inhibitors

Suitable choline salts or 2-hydroxyethyl trimethylammonium salts for use in this invention include, without limitation, choline organic counterion salts, choline inorganic counterion salts, or mixture or combinations thereof. Preferred choline counterion salts of this invention include, without limitation, choline or 2-hydroxyethyl trimethylammonium halide counterion salts, carboxylate counterion salts, nitrogen oxide counterion salts, phosphorus oxide counterion salts, sulfur oxide counterion salts, halogen oxide counterion salts, metal oxide counterion salts, carbon oxide counterion salts, boron oxide counterion salts, perfluoro counterion salts, hydrogen oxide counterion salts or mixtures or combinations thereof. Other examples can be found in U.S. patent application Ser. No. 10/999,796, incorporated herein by reference.

Exemplary examples of choline halide counterion salts including choline fluoride, choline chloride, choline bromide, choline iodide, or mixtures or combinations thereof.

Suitable choline carboxylate counterion salts include, without limitation, choline carboxylate counterion salts where the carboxylate counterion is of the general formula R¹COO⁻, where R¹ is an alkyl group, alkenyl group, alkynyl group, an aryl group, an alkaryl group, an aralkyl group, alkenylaryl group, aralkenyl group, alkynylaryl group, aralkynyl group hetero atom analogs, where the hetero atom is selected from the group consisting of boron, nitrogen, oxygen, fluorine, phosphorus, sulfur, chlorine, bromine, iodine, and mixture or combinations thereof, or mixtures or combinations thereof. A non-exhaustive list of exemplary examples of choline carboxylate counterion salts include choline formate, choline acetate, choline propanate, choline butanate, cholide pentanate, choline hexanate, choline heptanate, choline octanate, choline nonanate, choline decanate, choline undecanate, choline dodecanate, and choline higher linear carboxylate salts, choline benzoate, choline salicylate, other choline aromatic carboxylate counterion salts, choline stearate, choline oleate, other choline fatty acid counterion salts, choline glyolate, choline lactate, choline hydroxyl acetate, choline citrate, other choline hydroxylated carboxylates counterion salts, choline aconitate, choline cyanurate, choline oxalate, choline tartarate, choline itaconate, other choline di, tri and polycarboxylate counterion salts, choline trichloroacetate, choline trifluoroacetate, other choline halogenated carboxylate counterion salts, or mixture or combinations thereof. Other choline carboxylate counterion salts useful in the drilling fluids of this invention include choline amino acid counterion salts including choline salts of all naturally occurring and synthetic amino acids such as alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, (R)-Boc-4-(4-pyridyl)-β-Homoala-OH purum, (S)-Boc-4-(4-pyridyl)-β-Homoala-OH purum, (R)-Boc-4-trifluoromethyl-β-Homophe-OH purum, (S)-Fmoc-3-trifluoromethyl-β-Homophe-OH purum, (S)-Boc-3-trifluoromethyl-β-Homophe-OH purum, (S)-Boc-2-trifluoromethyl-β-Homophe-OH purum, (S)-Fmoc-4-chloro-β-Homophe-OH purum, (S)-Boc-4-methyl-β-Homophe-OH purum, 4-(Trifluoromethyl)-L-phenylalanine purum, 2-(Trifluoromethyl)-D-phenylalanine purum, 4-(Trifluoromethyl)-D-phenylalanine purum, 3 -(2-Pyridyl)-L-alanine purum, 3 -(2-Pyridyl)-L-alanine purum, 3-(3-Pyridyl)-L-alanine purum, or mixtures or combinations thereof or mixtures or combinations of these amino acid choline salts with other choline salts. Other preferred carboxylate counterions are counterions formed from a reaction of a carboxylic acid or carboxylate salt with an alkenyl oxide to form a carboxylate polyalkylene oxide alkoxide counterion salt. Preferred alkenyl oxides include ethylene oxide, propylene oxide, butylene oxide, and mixtures and/or combinations thereof.

Exemplary examples of choline nitrogen oxide counterion salts including choline nitrate, choline nitrite, choline NₓO_{y} counterion salts or mixtures or combinations thereof.

Exemplary examples of choline phosphorus oxide counterion salts include choline phosphate, choline phosphite, choline hydrogen phosphate, choline dihydrogen phosphate, choline hydrogen phosphite, choline dihydrogen phosphite, or mixtures or combinations thereof.

Exemplary examples of choline sulfur oxide counterion salts include choline sulfate, choline hydrogen sulfate, choline persulfate, choline alkali metal sulfates, choline alkaline earth metal sulfates, choline sulfonate, choline alkylsulfonates, choline sulfamate (NH₂SO₃⁻), choline taurinate (NH₂CH₂CH₂SO₃⁻), or mixtures or combinations thereof.

Exemplary examples of choline halogen oxide counterion salts including choline chlorate, choline bromate, choline iodate, choline perchlorate, choline perbromate, choline periodate, or mixtures or combinations thereof.

Exemplary examples of choline metal oxide counterion salts including choline dichromate, choline iron citrate, choline iron oxalate, choline iron sulfate, choline tetrathiocyanatodiamminechromate, choline tetrathiomolybdate, or mixtures or combinations thereof.

Exemplary examples of choline carbon oxide counterion salts include choline carbonate, choline bicarbonate, choline alkali carbonates, choline alkaline earth metal carbonates, or mixtures or combinations thereof.

Exemplary examples of choline boron oxide counterion salts including choline borate, tetraphenyl borate, or mixtures or combinations thereof.

Exemplary examples of choline perfluoro counterion salts including choline tetrafluoroborate, choline hexafluoroantimonate, choline heptafluorotantalate(V), choline hexafluorogermanate(IV), choline hexafluorophsophate, choline hexafluorosilicate, choline hexafluorotitanate, choline metavanadate, choline metatungstate, choline molybdate, choline phosphomolybdate, choline trifluoroacetate, choline trifluoromethanesulfonate, or mixtures or combinations thereof.

Exemplary examples of choline hydrogen oxide counterion salts including choline hydroxide, choline peroxide, choline superoxide, mixtures or combinations thereof. hydroxide reacted with: formic acid; acetic acid; phosphoric acid; hydroxy acetic acid; nitric acid; nitrous acid; poly phos; derivatives of P₂O₅; acid;(acid of glyoxal);; sulfuric; all the amino acids (lycine, torine, glycine, etc.); NH₂CH₂CH₂SO₃H; sulfamic; idodic; all the fatty acids; diamethylol proprionic acid; cyclolaucine; phosphorous; boric; proline; benzoic acid; tertiary chloro acetic; fumeric; salicylic; choline derivatives; ethylene oxide; propylene oxide; butylene oxide; epilene chloro hydrine; ethylene chloro hydrine; choline carbonate; and choline peroxide.

One preferred class of choline salts of this invention is given by the general formula (I):

HOCH₂CH₂N⁺(CH₃)₃.R¹COO⁻ (I)

where R¹ is an alkyl group, alkenyl group, alkynyl group, an aryl group, an alkaryl group, an aralkyl group, alkenylaryl group, aralkenyl group, alkynylaryl group, aralkynyl group hetero atom analogs, where the hetero atom is selected from the group consisting of boron, nitrogen, oxygen, fluorine, phosphorus, sulfur, chlorine, bromine, iodine, and mixture or combinations thereof, or mixtures or combinations thereof.

While choline halides have been used in drilling, completion and production operations under over-balanced conditions, choline carboxylate salts have not been used in such applications. These new anti-swell additives should enjoy broad utility in all conventional drilling, completion and/or production fluids.

### pH Modifiers

Suitable pH modifiers for use in this invention include, without limitation, alkali hydroxides, alkali carbonates, alkali bicarbonates, alkaline earth metal hydroxides, alkaline earth metal carbonates, alkaline earth metal bicarbonates and mixtures or combinations thereof. Preferred pH modifiers include NaOH, KOH, Ca(OH)₂, CaO, Na₂CO₃, KHCO₃, K₂CO₃, NaHCO₃, MgO, Mg(OH)₂ and combination thereof.

### Weight Reducing Agents and Foamers

The weight reducing agents and foamers use for this invention include, without limitation, any weight reducing agent or foamer currently available or that will be come available during the life time of this patent application or patent maturing therefrom. Preferred foamers are those available from Weatherford International, Inc. facility in Elmendorf, Tex. Generally, the foamers used in this invention can include alone or in any combination an anionic surfactant, a cationic surfactant, a non-ionic surfactant and a zwitterionic surfactant. Preferred foaming agents includes those disclosed in co-pending U.S. patent application Ser. No. 10/839,734 filed May 5, 2004.

### Other Corrosion Inhibitors

Suitable corrosion inhibitor for use in this invention include, without limitation: quaternary ammonium salts e.g., chloride, bromides, iodides, dimethylsulfates, diethylsulfates, nitrites, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C₆ to C₂₄ synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts ofnitrogen bases, include, without limitation, salts of nitrogen bases derived from a salt, e.g.: C₁ to C₈ monocarboxylic acids such as formic acid, acetic acid, propanoic acid, butanoic acid, pentanoic acid, hexanoic acid, heptanoic acid, octanoic acid, 2-ethylhexanoic acid, or the like; C₂ to C₁₂ dicarboxylic acids, C₂ to C₁₂ unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

### Other Additives

The drilling fluids of this invention can also include other additives as well such as scale inhibitors, carbon dioxide control additives, paraffin control additives, oxygen control additives, or other additives.

### Scale Control

Suitable additives for Scale Control and useful in the compositions of this invention include, without limitation: Chelating agents, e.g., Na, K or NH₄⁺ salts of EDTA; Na, K or NH₄⁺ salts of NTA; Na, K or NH₄⁺ salts of Erythorbic acid; Na, K or NH₄⁺ salts of thioglycolic acid (TGA); Na, K or NH₄⁺ salts of Hydroxy acetic acid; Na, K or NH₄⁺ salts of Citric acid; Na, K or NH₄⁺ salts of Tartaric acid or other similar salts or mixtures or combinations thereof. Suitable additives that work on threshold effects, sequestrants, include, without limitation: Phosphates, e.g., sodium hexametaphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

### Carbon Dioxide Neutralization

Suitable additives for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of aminoethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

### Paraffin Control

Suitable additives for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils soy oils or C10 to C24 amines or monohalogenated alkyl and aryl chlorides; quanternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids and/or N-methyl-2-pyrrolidone is oil solubility is desired.

### Oxygen Control and Oxygen Scavengers

The introduction of water downhole often is accompanied by an increase in the oxygen content of downhole fluids due to oxygen dissolved in the water introduced downhole. Thus, the materials introduced downhole must work in oxygen environments or must work sufficiently well until the oxygen content has been depleted by natural reactions. For system that cannot tolerate oxygen, then oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to produce sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Exemplary examples oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

### Fracturing Fluids

The hydraulic fracturing fluids of this invention are low corrosive or non-corrosive phosphate brines. The fracturing operation generally involves pumping a proppant-free fluid of this invention as a viscous fluid, or pad, usually with some fluid additives to generate high viscosity, into a well faster than the fluid can escape into the formation so that the pressure rises and the rock breaks, creating artificial fractures and/or enlarging existing fractures. After fracturing the formation, a propping agent, generally a solid material such as sand is added to the fluid to form a slurry that is pumped into the newly formed fractures and/or enlarged fractures in the formation to prevent them from closing when the pumping pressure is released. The proppant transport ability of a base fluid depends on the type of viscosifying additives added to the water base. Alternatively, the proppant can be present in the fracturing fluid from the outset.

Water-base fracturing fluids with water-soluble polymers added to make a viscosified solution are widely used in the art of fracturing. Since the late 1950s, more than half of the fracturing treatments are conducted with fluids comprising guar gums, high-molecular weight polysaccharides composed of mannose and galactose sugars, or guar derivatives such as hydropropyl guar (HPG), carboxymethyl guar (CMG). carboxymethylhydropropyl guar (CMHPG). Crosslinking agents based on boron, titanium, zirconium or aluminum complexes are typically used to increase the effective molecular weight of the polymer and make them better suited for use in high-temperature wells.

Polymer-free, water-base fracturing fluids can be obtained using viscoelastic surfactants. These fluids are normally prepared by mixing in appropriate amounts of suitable surfactants such as anionic, cationic, nonionic and zwitterionic surfactants. The viscosity of viscoelastic surfactant fluids is attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

The proppant type can be sand, intermediate strength ceramic proppants (available from Carbo Ceramics, Norton Proppants, etc.), sintered bauxites and other materials known to the industry. Any of these base propping agents can further be coated with a resin (available from Santrol, a Division of Fairmount Industries, Borden Chemical, etc.) to potentially improve the clustering ability of the proppant. In addition, the proppant can be coated with resin or a proppant flowback control agent such as fibers for instance can be simultaneously pumped. By selecting proppants having a contrast in one of such properties such as density, size and concentrations, different settling rates will be achieved.

In order for the treatment to be successful, it is preferred that the fluid viscosity eventually diminish to levels approaching that of water after the proppant is placed. This allows a portion of the treating fluid to be recovered without producing excessive amounts of proppant after the well is opened and returned to production. The recovery of the fracturing fluid is accomplished by reducing the viscosity of the fluid to a lower value such that it flows naturally from the formation under the influence of formation fluids. This viscosity reduction or conversion is referred to as “breaking” and can be accomplished by incorporating chemical agents, referred to as “breakers,” into the initial gel.

In addition to the importance of providing a breaking mechanism for the gelled fluid to facilitate recovery of the fluid and to resume production, the timing of the break is also of great importance. Gels which break prematurely can cause suspended proppant material to settle out of the gel before being introduced a sufficient distance into the produced fracture. Premature breaking can also lead to a premature reduction in the fluid viscosity, resulting in a less than desirable fracture width in the formation causing excessive injection pressures and premature termination of the treatment.

Suitable solvents for use in this invention include, without limitation, water. The solvent may be an aqueous potassium chloride solution.

Suitable inorganic breaking agents include, without limitation, a metal-based oxidizing agent, such as an alkaline earth metal or a transition metal; magnesium peroxide, calcium peroxide, or zinc peroxide.

Suitable ester compounds include, without limitation, an ester of a polycarboxylic acid, e.g., an ester of oxalate, citrate, or ethylene diamine tetraacetate. Ester compound having hydroxyl groups can also be acetylated, e.g., acetylated citric acid to form acetyl triethyl citrate.

Suitable hydratable polymers that may be used in embodiments of the invention include any of the hydratable polysaccharides which are capable of forming a gel in the presence of a crosslinking agent. For instance, suitable hydratable polysaccharides include, but are not limited to, galactomannan gums, glucomannan gums, guars, derived guars, and cellulose derivatives. Specific examples are guar gum, guar gum derivatives, locust bean gum, Karaya gum, carboxymethyl cellulose, carboxymethyl hydroxyethyl cellulose, and hydroxyethyl cellulose. Presently preferred gelling agents include, but are not limited to, guar gums, hydroxypropyl guar, carboxymethyl hydroxypropyl guar, carboxymethyl guar, and carboxymethyl hydroxyethyl cellulose. Suitable hydratable polymers may also include synthetic polymers, such as polyvinyl alcohol, polyacrylamides, poly-2-amino-2-methyl propane sulfonic acid, and various other synthetic polymers and copolymers. Other suitable polymers are known to those skilled in the art.

The hydratable polymer may be present in the fluid in concentrations ranging from about 0.10% to about 5.0% by weight of the aqueous fluid. In certain embodiment, a range for the hydratable polymer is about 0.20% to about 0.80% by weight.

A suitable crosslinking agent can be any compound that increases the viscosity of the fluid by chemical crosslinking, physical crosslinking, or any other mechanisms. For example, the gellation of a hydratable polymer can be achieved by crosslinking the polymer with metal ions including boron, zirconium, and titanium containing compounds, or mixtures thereof. One class of suitable crosslinking agents is organotitanates. Another class of suitable crosslinking agents is borates as described, for example, in U.S. Pat. No. 4,514,309. The selection of an appropriate crosslinking agent depends upon the type of treatment to be performed and the hydratable polymer to be used. The amount of the crosslinking agent used also depends upon the well conditions and the type of treatment to be effected, but is generally in the range of from about 10 ppm to about 1000 ppm of metal ion of the crosslinking agent in the hydratable polymer fluid. In some applications, the aqueous polymer solution is crosslinked immediately upon addition of the crosslinking agent to form a highly viscous gel. In other applications, the reaction of the crosslinking agent can be retarded so that viscous gel formation does not occur until the desired time.

It should be understood that the above-described method is only one way to carry out embodiments of the invention. The following U.S. patents disclose various techniques for conducting hydraulic fracturing which may be employed in embodiments of the invention with or without modifications: U.S. Pat. Nos. 6,793,018; 6,756,345; 6,169,058; 6,135,205; 6,123,394; 6,016,871; 5,755,286; 5,722,490; 5,711,396; 5,551,516; 5,497,831; 5,488,083; 5,482,116; 5,472,049; 5,411,091; 5,402,846; 5,392,195; 5,363,919; 5,228,510; 5,224,546; 5,074,359; 5,024,276; 5,005,645; 4,938,286; 4,926,940; 4,892,147; 4,869,322; 4,852,650; 4,848,468; 4,846,277; 4,830,106; 4,817,717; 4,779,680; 4,479,041; 4,739,834; 4,724,905; 4,718,490; 4,714,115; 4,705,113; 4,660,643; 4,657,081; 4,623,021; 4,549,608; 4,541,935; 4,378,845; 4,067,389; 4,007,792; 3,965,982; 3,960,736; and 3,933,205, (incorporated herein by reference by action of the last paragraph of the disclosure prior to the claims).

The liquid carrier can generally be any liquid carrier suitable for use in oil and gas producing wells. A presently preferred liquid carrier is water. The liquid carrier can comprise water, can consist essentially of water, or can consist of water. Water will typically be a major component by weight of the fluid. The water can be potable or non-potable water. The water can be brackish or contain other materials typical of sources of water found in or near oil fields. For example, it is possible to use fresh water, brine, or even water to which any salt, such as an alkali metal or alkali earth metal salt (NaCO₃, NaCl, KCl, etc.) has been added. The liquid carrier is preferably present in an amount of at least about 80% by weight. Specific examples of the amount of liquid carrier include 80%, 85%, 90%, and 95% by weight.

All the fracturing fluids described above are described herein in relationship to the sole use or combined use of a microbial based viscosity breaking composition, apparatus or method of this invention. Of course, the microbial based viscosity breaking composition, apparatus or method of this invention can be used in conjunction or combinations of other gelling and breaking compositions to achieve a desired fracturing and breaking profile (viscosity versus time profile).

### EXPERIMENTS OF THE INVENTION

### EXAMPLE 1

This example illustrates neutralization of phosphate brines (referred to as “Brine” in Table 1). Thus, taking required amount of brine, neat or diluted solution of acid was added (until desired pH was attained) with vigorous stirring. Where applicable, distilled water was added to dissolve precipitates in resultant solution until clear. Then, final pH and density were determined recorded and tabulated in Table I.

TABLE I
Neutralization of the Phosphate Brines of Example 1

| | | | | | | |
|---|---|---|---|---|---|---|
| Brine | [Acid] | [H₂O] | | | Density | |
| (mL) | (mL) | (mL) | pHᵢ | pH_{f} | (ppg) | Comment |

Methyl Sulfonic Acid (70%)

| | | | | | | |
|---|---|---|---|---|---|---|
| 20.00 | 0.00 | — | 9.31 | | 13.22 | |
| | 2.00 | — | — | | — | precipitate seen |
| | ±2.00 | — | — | 8.47 | — | |
| | ±1.00 | 9.00 | — | 7.00 | 12.27 | clear/thorough |
| | | | | | | mixing |

Glycolic Acid

| | | | | | | |
|---|---|---|---|---|---|---|
| 20.0 | 0.00 | — | 9.31 | | 13.22 | |
| | 1.5 | — | — | 8.5 | — | no precipitate seen |
| | ±0.5 | — | — | 8.33 | — | |
| | ±0.8 | — | — | 8.2 | — | cloudy |
| | ±0.8 | 10.0 | — | 7.8 | 12.18 | clear solution |

Formic Acid

| | | | | | | |
|---|---|---|---|---|---|---|
| 20.0 | 0.0 | — | 9.31 | — | 13.22 | |
| | 0.9 | — | — | 8.12 | — | cloudy |
| | ±0.7 | — | — | 8.07 | — | precipitate seen |
| | — | 20.0 | — | 7.00 | 11.52 | clear solution |

Hydrochloric Acid (36%)

| | | | | | | |
|---|---|---|---|---|---|---|
| 20.0 | 0.0 | — | 9.31 | — | 13.22 | |
| | 2.0 | — | — | 8.09 | — | slight precipitate |
| | | | | | | seen |
| | ±1.0 | — | — | 7.79 | — | |
| | — | 9.0 | — | 7.25 | 12.02 | clear solution |

Polyphosphoric Acid (115%)

| | | | | | | |
|---|---|---|---|---|---|---|
| 20.0 | 0.0 | — | 9.31 | — | 13.2 | |
| | 3.52 g | | | 7.69 | | cloudy (slight) |
| | | 9.0 | | 7.45 | | clear solution |
| | | | 9.93 | | 14.22 | |
| 20.0 | | 4.90 g | | | 6.58 | clear solution |

pHᵢ = initial pH; pH_{f} = final pH.

### EXAMPLE 2

This example illustrate the preparation and testing of neutralized phosphate brines having a density of 14.2 ppg.

To a 250 mL sample of a 14.2 ppg phosphate brine were added all at once with an amount of a neutralizing system and stirred for 30 minutes, to insure the formation of a true solution or suspension—a medium with even distribution or uniform distribution of the additives. The neutralizing systems included Corsa SF, OxBan HB, CF-1 and TAN. The solutions were then charged into aging cells (316 SS) with carbon steel coupons blanketed with membrane nitrogen (circa 4% O₂) to a pressure of 300 psi. The cell is then rolled at 250° F. (or as indicated) for 16 h (or as indicated).

The sample test results are tabulated in Table II. In the table, IWt. means initial weight, FWt. means final weight, and Wt. loss means weight loss.

TABLE II
Corrosion Testing at 250° F. of the Phosphate Brines of Example 2

| Cell# | Coupon # | Test Solution | IWt. | FWt. | Wt. Loss |
|---|---|---|---|---|---|
| 1 | 75 | 1.0 mL OBHB^{†} | 21.1853 | 21.1490 | 0.0363 |
| 2 | 76 | 1.0 mL CSF^{‡} | 21.3220 | 20.9924 | 0.3296 |
| 3 | 77 | Tap Water | 21.1592 | 20.8223 | 0.3369 |
| 4 | 78 | 1.0 mL CF-1⁺ | 21.4635 | 21.1034 | 0.3601 |
| 5 | 79 | 1.0 mL CSF^{‡} | 21.1893 | 20.9360 | 0.2533 |
| 6 | 80 | 1.0 mL TAN* | 21.5068 | 21.2801 | 0.2267 |

| Cell# | Coupon # | Days | Corr (MPY) | Corr (lb/ft²/yr) | Pitting |
|---|---|---|---|---|---|
| 1 | 75 | 1 | 29.7 | 1.21 | None |
| 2 | 76 | 1 | 269.4 | 10.95 | Slight |
| 3 | 77 | 1 | 275.3 | 11.19 | Slight |
| 4 | 78 | 1 | 294.3 | 11.96 | Slight |
| 5 | 79 | 1 | 207.0 | 8.42 | Slight |
| 6 | 80 | 1 | 185.3 | 7.53 | Slight |

^{†}OBHB is OxBan HB available from Tetra Technologies, Inc. USA.
^{‡}CSF is CORSAF ™ SF available from Tetra Technologies, Inc. USA.
⁺CF-1 is CorrFoam ™ 1 available from Weatherford International, USA
*TAN is Triaminononane Crude available from NOVA Molecular Technologies, Inc. USA

### EXAMPLE 3

This example illustrate the preparation and testing of neutralized phosphate brines having a density of 14.2 ppg.

To a 250 mL sample of a 14.2 ppg phosphate brine was added all at once an amount of inhibitor system and stirred for 30 minutes, to insure true solution or suspension—a medium with even distribution or uniform distribution of the additive. The neutralizing systems included Corsa SF and OxBan HB. The solutions were then charged into aging cells (316 SS) with carbon steel coupons blanketed with membrane nitrogen (circa 4% O₂) to a pressure of 300 psi. The cell is then rolled at 250° F. (or as indicated) for 16 h (or as indicated).

The sample test results are tabulated in Table III. In the table, IWt. means initial weight, FWt. means final weight, and Wt. loss means weight loss.

TABLE III
Corrosion Testing @ 250° F. of
the Phosphate Brines of Example 3

| Cell# | Coupon # | Test Solution | IWt. | FWt. | Wt. Loss |
|---|---|---|---|---|---|
| 1 | 22 | Brine, | 20.1248 | 19.8707 | 0.2541 |
| | | 0.25 mL CSF^{‡} | | | |
| 2 | 23 | Brine, | 20.1901 | 19.8007 | 0.3894 |
| | | 0.25 mL OBHB^{†} | | | |
| 3 | 24 | Brine, | 20.1720 | 19.9297 | 0.2423 |
| | | 0.25 mL CSF^{‡} | | | |
| 4 | 25 | Brine, | 20.2470 | 19.8462 | 0.4008 |
| | | 0.25 mL OBHB^{†} | | | |
| 5 | 26 | Brine, | 20.2513 | 19.8803 | 0.3710 |
| | | 0.50 mL OBHB^{†} | | | |
| 6 | 27 | Brine, | 20.2640 | 20.0078 | 0.2562 |
| | | 0.50 mL CSF^{‡} | | | |

| Cell# | Coupon # | Days | Corr (MPY) | Corr (lb/ft²/yr) | Pitting |
|---|---|---|---|---|---|
| 1 | 22 | 1 | 207.7 | 8.44 | None |
| 2 | 23 | 1 | 318.3 | 12.94 | None |
| 3 | 24 | 1 | 198.0 | 8.05 | None |
| 4 | 25 | 1 | 327.6 | 13.32 | None |
| 5 | 26 | 1 | 303.2 | 12.33 | None |
| 6 | 27 | 1 | 209.4 | 8.51 | None |

^{†}OBHB is OxBan HB available from Tetra Technologies, Inc. USA.
^{‡}CSF is CORSAF ™ SF available from Tetra Technologies, Inc. USA.

### EXAMPLE 4

This example illustrate the preparation and testing of partially neutralized phosphate brines having a density of 14.2 ppg.

To a 250 mL sample of a 14 ppg phosphate brine was added all at once an amount of a neutralizing system and stirred for 30 minutes, to insure true solution or suspension—a medium with even distribution or uniform distribution of the additive. The neutralizing systems included Corsa SF, OxBan HB, CF-1 and TAN. The solutions were then charged into aging cells (316 SS) with carbon steel coupons blanketed with membrane nitrogen (circa 4% O₂) to a pressure of 300 psi. The cell is then rolled at 250° F. (or as indicated) for 16 h (or as indicated).

The sample test results are tabulated in Table IV. In the table, IWt. means initial weight, FWt. means final weight, and Wt. loss means weight loss.

TABLE IV
Corrosion Testing @ 250° F. of the Phosphate Brines of Example 4

| Cell# | Coupon # | Test Solution | IWt. | FWt. | Wt. Loss |
|---|---|---|---|---|---|
| Blk | | Phosphate Brine (14.22 ppg) | 21.2066 | 19.1944 | 2.0122 |
| 1 | 28 | 4 mL, LMSA** | 20.3686 | 19.5466 | 0.8220 |
| 2 | 29 | 5 mL, LMSA** | 21.0998 | 20.2797 | 0.8201 |
| 3 | 30 | 6 mL, LMSA** | 21.2837 | 20.4089 | 0.8748 |
| 4 | 81 | 7 mL, LMSA** | 21.5617 | 20.7065 | 0.8552 |
| 5 | 82 | 5 mL LMSA, 0.25 mL CSF^{‡} | 19.4745 | 19.1579 | 0.3166 |
| 6 | 83 | 5 mL LMSA, 0.25 mL OBHB^{†} | 19.4768 | 18.6089 | 0.8679 |
| 7 | 19 | 10 mL BARDAC ® LF⁺ | 20.0575 | 19.8272 | 0.2303 |

| Cell# | Coupon # | Days | Corr (MPY) | Corr (lb/ft²/yr) | Pitting | pH |
|---|---|---|---|---|---|---|
| Blk | | 2 | 1685.7 | 68.52 | Yes | |
| 1 | 28 | 2 | 335.9 | 13.65 | Yes | 9.2 |
| 2 | 29 | 2 | 335.1 | 13.62 | Yes | 9.2 |
| 3 | 30 | 2 | 357.5 | 14.53 | Yes | 9.2 |
| 4 | 81 | 2 | 349.5 | 14.21 | Yes | 9.2 |
| 5 | 82 | 2 | 129.4 | 5.26 | Yes | 9.2 |
| 6 | 83 | 2 | 354.7 | 14.42 | Yes | 9.2 |
| 7 | 19 | 1 | 188.3 | 7.7 | Slight | 8.97 |

^{†}OBHB is OxBan HB available from Tetra Technologies, Inc. USA.
^{‡}CSF is CORSAF ™ SF available from Tetra Technologies, Inc. USA.
**LMSA is Lutropur MSA (methane sulfonic acid) from BASF Corp. USA.
⁺BARDAC ® LF is a quaternary biocides available from Lonza Inc. Allendale, NJ

### EXAMPLE 5

This example illustrate the preparation and testing of partially neutralized phosphate brines having a density of 14.2 ppg.

To a 250 mL sample of a 14.2 ppg phosphate brine was added all at once an amount of a neutralizing system and stirred for 30 minutes, to insure true solution or suspension—a medium with even distribution or uniform distribution of the additive. The neutralizing systems included Corsa SF, OxBan HB, CF-1 and TAN. The solutions were then charged into aging cells (316 SS) with carbon steel coupons blanketed with membrane nitrogen to a pressure of 300 psi. The cell is then rolled at 250° F. (or as indicated) for 16 h (or as indicated).

The sample test results are tabulated in Table V. In the table, IWt. means initial weight, FWt. means final weight, and Wt. loss means weight loss.

TABLE V
Corrosion Testing @ 250° F. 250 mL of the Phosphate Brines of Example 5

| Cell# | Coupon # | Test Solution | IWt | FWt | Wt. Loss |
|---|---|---|---|---|---|
| 1 | 84 | 5 mL LMSA**, 2 mL CSF^{‡} | 21.1823 | 20.9396 | 0.2427 |
| 2 | 85 | 10 mL LMSA**, 0.25 mL CSF^{‡} | 21.0400 | 20.8308 | 0.2092 |
| 3 | 86 | 5 mL LMSA**, 0.5 mL CSF^{‡} | 20.8605 | 20.6134 | 0.2471 |
| 4 | 87 | 5 mL LMSA**, 1.0 mL CSF^{‡} | 20.6321 | 20.3926 | 0.2395 |
| 5 | 88 | 2.5 mL LMSA**, 0.25 mL CSF^{‡} | 20.4008 | 20.1438 | 0.2570 |
| 6 | 89 | 5 mL LMSA**, 0.5 mL BA | 20.5728 | 20.1214 | 0.4514 |

| Cell# | Coupon # | Corr (MPY) | Corr (lb/ft²/yr) | Pitting |
|---|---|---|---|---|
| 1 | 84 | 198.4 | 8.06 | Medium |
| 2 | 85 | 171.0 | 6.95 | Medium |
| 3 | 86 | 202.0 | 8.21 | Medium |
| 4 | 87 | 195.7 | 7.96 | Medium |
| 5 | 88 | 210.0 | 8.54 | Medium |
| 6 | 89 | 368.9 | 15.00 | Medium |

^{‡}CSF is CORSAF SF available from Tetra Technologies, Inc. USA.
⁺LMSA is Lutropur MSA (methane sulfonic acid) from BASF Corp. USA
*BA is benzoic acid from Sigma-Aldrich Co. USA

### EXAMPLE 6

The following example illustrates the corrosiveness of phosphate brines having a density of 14.2 ppg under ambient conditions (1 atmosphere, 150° F.) compared to calcium bromide (14.2 ppg). Thus, the phosphate brine posses no deleterious effect on metals at 150° F. like CaBr₂.

To a 250 mL sample of a 14.2 ppg phosphate brine was added carbon steel coupon such that the coupon is fully immersed in the brine solution. The solution was then left to stand for 7 days. Similar procedure was followed for CaBr₂.

The sample test results are tabulated in Table VI.

TABLE VI
Corrosion Jar Testing @ 150° F. for 7 Days of the Phosphate Brines of Example 6

| Jar# | Coupon # | T ° F. | Test Solution | IWt. | FWt. | Wt. Loss |
|---|---|---|---|---|---|---|
| 1 | 182 | 150 | Phosphate Brine (14.22 ppg) | 22.4165 | 22.2568 | 0.1597 |
| 2 | 183 | 150 | CaBr₂ 14.2 ppg | 22.3588 | 22.3512 | 0.0076 |

| Jar# | Coupon # | Days | Corr (MPY) | Corr (lb/ft²/yr) | Pitting |
|---|---|---|---|---|---|
| 1 | 182 | 7 | 18.6 | 0.76 | None |
| 2 | 183 | 7 | 0.9 | 0.04 | None |

The data from the above examples show that low corrosive phosphate brines can be prepared through the addition of an additive system in an amount sufficient to affect at least about 50% reduction in corrosive ratings such as MPY or lb/ft²/yr compared to the same phosphate brine in the absence of the additive system. In certain embodiment, the low corrosive phosphate brines having a to affect at least about 60% reduction in corrosive ratings such as MPY or lb/ft²/yr compared to the same phosphate brine in the absence of the additive system. In certain embodiment, the low corrosive phosphate brines having a to affect at least about 70% reduction in corrosive ratings such as MPY or lb/ft²/yr compared to the same phosphate brine in the absence of the additive system. In certain embodiment, the low corrosive phosphate brines having a to affect at least about 75% reduction in corrosive ratings such as MPY or lb/ft²/yr compared to the same phosphate brine in the absence of the additive system. In certain embodiment, the low corrosive phosphate brines having a to affect at least about 75% reduction in corrosive ratings such as MPY or lb/ft²/yr compared to the same phosphate brine in the absence of the additive system. The term about means the value can vary about is value by ±10%.

The effective amount of the additive system ranges from about 0.01 vol. % to about 10 vol. %. In certain embodiments additive system ranges from about 0.05 vol. % to about 5 vol. %. In certain embodiments additive system ranges from about 0.1 vol. % to about 5 vol. %.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1. A composition comprising:
a phosphate brine including an effective amount of an additive system, where the effective amount is sufficient to produce a phosphate brine having a corrosion rating in lb/ft²/yr between about 0 and about 50.

2. The composition of claim 1, wherein the additive system comprises neutralization agents, oxygen scavengers, quaternary ammonium salts, amines, quaternary phosphonium salts, phosphines or mixtures and combinations thereof.

3. The composition of claim 2, wherein the neutralizing agents comprises acids, anhydrides, or mixtures or combinations thereof.

4. The composition of claim 3, wherein the acids and anhydrides comprise organic acids, organic acid anhydrides, inorganic acids, inorganic acid anhydrides or mixtures and combinations thereof.

5. The composition of claim 4, wherein the organic acids comprise carboxylic acids (mono, di or poly), halogen containing acids, sulfur containing acids, phosphorus containing acids or mixtures and combinations thereof.

6. The composition of claim 5, wherein the carboxylic acids comprise saturated carboxy acids having from 1 to about 20 carbon atoms, unsaturated carboxy acids having from about 2 to about 20 carbon atoms, aromatic acids having from about 5 to about 30 carbon atoms, saturated dicarboxy acids having from 1 to about 20 carbon atoms, unsaturated dicarboxy acids having from about 2 to about 20 carbon atoms, aromatic diacids having from about 5 to about 30 carbon atoms, saturated polycarboxy acids having from 1 to about 20 carbon atoms, unsaturated polycarboxy acids having from about 2 to about 20 carbon atoms, aromatic polyacids having from about 5 to about 30 carbon atoms, or mixtures and combinations thereof, where one or more of the carbon atoms may be replaced by hetero atoms including boron, nitrogen, oxygen, sulfur, or mixtures thereof and one or more of the required hydrogen atoms to complete the valency may be replaced by a halogen including fluorine, chlorine, or bromine, a hydroxyl group, an ether group, an amine, an amide, or mixtures thereof.

7. The composition of claim 5, wherein the sulfonic acids include, without limitation, alkyl sulfonic acids, alkenyl sulfonic acids, aryl sulfonic acids, where the alkyl groups include 1 to about 20 carbon atoms, the alkenyl groups include 2 to about 20 carbon atoms and the aryl groups include 5 to about 30 carbon atoms, where one or more of the carbon atoms may be replaced by hetero atoms including boron, nitrogen, oxygen, sulfur, or mixtures thereof and one or more of the required hydrogen atoms to complete the valency may be replaced by a halogen including fluorine, chlorine, or bromine, a hydroxyl group, an ether group, an amine, an amide, or mixtures thereof.

8. The composition of claim 1, wherein the quaternary ammonium salts, amines, quaternary phosphonium salts, phosphines comprises quaternary ammonium salts of the general formula R¹R²R³R⁴N⁺A⁻, quaternary phosphonium of the general formula R¹R²R³R⁴P⁺A⁻, amines of the general formula R¹R²R³N, phosphines of the general formula R¹R²R³P, or mixtures and combinations thereof, where the R¹, R², R³ and R⁴ are the same or different and are carbyl groups having between 1 and about 20 carbon atoms having sufficient hydrogen atoms to satisfy the valence, where one or more carbon atoms may be replaced by a hetero atom or group selected from oxygen, sulfur, amido, boron, or mixtures thereof, and one or more of the hydrogen atoms can be replace by halogens, alkoxdies, or mixtures thereof and where A—is a counterion selected from the group consisting of hydroxide (OH—), halogens (F—, Cl—, Br—, I—), sulfate (SO₄²⁻), nitrate (NO₃²⁻), other counterions or mixtures thereof.

9. The composition of claim 1, wherein the effective amount is between about 0.01% and about 20% and where the brine has a density between about 10 ppg and about 20 ppg.

10. The composition of claim 1, wherein the corrosion rating in lb/ft²/yr between about 0 and about 40.

11. The composition of claim 1, wherein the corrosion rating in lb/ft²/yr between about 1 and about 30.

12. The composition of claim 1, wherein the corrosion rating in lb/ft²/yr between about 1 and about 25.

13. A method for fracturing a formation comprising:
pumping a fracturing composition into a formation at a pressure sufficient to fracture the formation in the presence or absence of a proppant, where the fracturing composition includes a phosphate brine including an effective amount of an additive system, where the effective amount is sufficient to produce a phosphate brine having a corrosion rating in lb/ft²/yr between about 0 and about 50.

14. The method of claim 13, wherein the additive system comprises neutralization agents, oxygen scavengers, quaternary ammonium salts, amines, quaternary phosphonium salts, phosphines or mixtures and combinations thereof.

15. The method of claim 14, wherein the neutralizing agents comprises acids, anhydrides, or mixtures or combinations thereof, where the acids and anhydrides comprise organic acids, organic acid anhydrides, inorganic acids, inorganic acid anhydrides or mixtures and combinations thereof and where the organic acids comprise carboxylic acids (mono, di or poly), halogen containing acids, sulfur containing acids, phosphorus containing acids or mixtures and combinations thereof.

16. The method of claim 13, wherein the effective amount is between about 0.01% and about 20% and where the brine has a density between about 10 ppg and about 20 ppg.

17. The method of claim 13, wherein the corrosion rating in lb/ft²/yr between about 1 and about 25.

18. A method for drilling an oil and/or gas well comprising:
circulating a drilling fluid composition while drilling a wellbore into a target formation, where the drilling fluid composition includes a phosphate brine including an effective amount of an additive system, where the effective amount is sufficient to produce a phosphate brine having a corrosion rating in lb/ft²/yr between about 0 and about 50.

19. The method of claim 18, wherein the additive system comprises neutralization agents, oxygen scavengers, quaternary ammonium salts, amines, quaternary phosphonium salts, phosphines or mixtures and combinations thereof.

20. The method of claim 19, wherein the neutralizing agents comprises acids, anhydrides, or mixtures or combinations thereof, where the acids and anhydrides comprise organic acids, organic acid anhydrides, inorganic acids, inorganic acid anhydrides or mixtures and combinations thereof and where the organic acids comprise carboxylic acids (mono, di or poly), halogen containing acids, sulfur containing acids, phosphorus containing acids or mixtures and combinations thereof.

21. The method of claim 18, wherein the effective amount is between about 0.01% and about 20% and where the brine has a density between about 10 ppg and about 20 ppg.

22. The method of claim 18, wherein the corrosion rating in lb/ft²/yr between about 1 and about 25.

23. A method for completion a oil and/or gas well comprising:
circulating a completion fluid composition during completion of a target formation, where the completion fluid composition includes a phosphate brine including an effective amount of an additive system, where the effective amount is sufficient to produce a phosphate brine having a corrosion rating in lb/ft²/yr between about 0 and about 50.

24. The method of claim 23, wherein the additive system comprises neutralization agents, oxygen scavengers, quaternary ammonium salts, amines, quaternary phosphonium salts, phosphines or mixtures and combinations thereof.

25. The method of claim 24, wherein the neutralizing agents comprises acids, anhydrides, or mixtures or combinations thereof, where the acids and anhydrides comprise organic acids, organic acid anhydrides, inorganic acids, inorganic acid anhydrides or mixtures and combinations thereof and where the organic acids comprise carboxylic acids (mono, di or poly), halogen containing acids, sulfur containing acids, phosphorus containing acids or mixtures and combinations thereof.

26. The method of claim 23, wherein the effective amount is between about 0.01% and about 20% and where the brine has a density between about 10 ppg and about 20 ppg.

27. The method of claim 23, wherein the corrosion rating in lb/ft²/yr between about 1 and about 25.
